(19) United States
(12) Patent Application Publication
(10) Pub. No.: US 2004/0139035 A1
(43) Pub. Date: Jul. 15, 2004

(54) System and method for integration of value-added product costs

(76) Inventor: Juei-Mei Wang, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/744,414

(22) Filed: Dec. 22, 2003

(30) Foreign Application Priority Data
Dec. 20, 2002 (TW) 91136971

(51) Int. Cl. G06G 7/00

(52) U.S. Cl. 705/400

(57) ABSTRACT

A system for integration of value-added product costs (1) can calculate a product's value-added costs according to manufacturing expenses and work time data on work orders. The system for integration of value-added product costs is connected to a number of client terminals (3), a general ledger management system (5), a manufacturing process management system (6) and a work order management system (8) via a network (2). The system for integration of value-added product costs includes a web server (12), a database server (14), and a database (16). The web server is connected to the database server, which contains the database. The web server stores a series of software function modules for receiving and processing data from the client terminals, and for returning results to the client terminals after processing. A related method is also provided.

### BACKGROUND OF THE INVENTION

1. Field of the Invention

The present invention relates to a system and method for cost accounting management, and especially to a system and method for integration of value-added product costs.

2. Background of the Invention

During the 1970s and 1980s, many private enterprises were able to prosper while paying relatively little attention to cost management. This was particularly the case with smaller manufacturing companies that were not significantly affected by international competition. Since that time, consolidation and corporate takeovers have led to the emergence of numerous large-scale enterprises, whose commercial activities are correspondingly complex and increasingly subject to intense international competition. When certain of these companies have been able to increase revenue but without enjoying corresponding increases in profit, their competence in the area of cost management has been called into question. As one of the most important aspects of corporate management, effective cost management is closely related to cost analysis and profit distribution. Cost management is fundamental to the competence and development of virtually every company.

At present, there are many types of computer systems and management methods related to cost management. Most of these systems and methods focus on collecting cost data, and adopting a single type of or simplified apportionment standard such as direct labor work time, machine work time etc. in order to apportion costs to a production cost center and then to a product. For example, US Patent Application Publication No. 2002/0069103 published on Jun. 6, 2002 provides “Methods and Systems Enabling the Identification of Actual Costs in a Transaction Based Financial and Manufacturing Environment.” The disclosed method and system collects actual cost data of at least one operation and actual cost data of at least one material from a business activity, gives each cost an identifier which corresponds to an operation or a material in the business activity, stores the actual cost data according to the identifiers, and then displays an output according to the actual cost data. However, this method can lead to underestimations or overestimations of product costs, and result in undercharging or overcharging of customers. The resulting inconsistencies between product costs and revenues from customers can cause corporate management to make wrong decisions.

What is needed is a system and method of cost management which overcomes the above-described problems.

### SUMMARY OF THE INVENTION

Accordingly, a main objective of the present invention is to provide a system and method for integration of product costs which, on the basis of manufacturing expenses and work order data, defines cost variances and apportionment values to be apportioned to each of operation centers, calculates total costs and an expenses rate of each operation center, obtains each product's costs from different operation centers, and calculates total costs of each product.

To achieve the above objective, a system for integration of product costs provided by the present invention comprises a web server and a database server. The database server comprises a database for storing cost variable definition data, operation center definition data, and manufacturing expenses data. The cost variable definition data comprises cost variance related data including a cost variance code field, a cost variance name field, a cost variance unit field and other fields. The operation center definition data comprises data on cost variables and work centers of each of operation centers. The manufacturing expenses data comprises expenses of each of manufacturing expenses accounts.

The web server comprises a cost group file creation module for defining cost groups, manufacturing expenses accounts and cost variables in each cost group, and for calculating the manufacturing expenses of each cost group based on the manufacturing expenses data and the cost variable definition data; an operation center variance calculation module for calculating the sum of all the operation centers' variances and each product's variance for each operation center, based on the operation center definition data and the work time data on work orders; a cost group apportionment module for specifying a ratio of each cost group's manufacturing expenses apportioned to each operation center; a costs integration module for calculating each operation center's total costs, each cost group's manufacturing costs corresponding to the operation center, and the operation center's apportioned variance; a manufacturing expenses account/amount transfer module for obtaining manufacturing expenses information, calculating manufacturing expenses data, and storing the manufacturing expenses data in a database; a cost variable definition module for defining cost variables, cost variable codes and other relevant data; an operation center maintenance module for selecting work centers in operation centers and specifying cost variables to be apportioned to product costs; and a costs enquiry module for handling queries to obtain data on total costs, an expenses rate and product costs of each operation center.

The present invention also provides a method for integration of value-added costs for a product. The method integrates a product's value-added costs based on manufacturing expenses and work time data on work orders. The method includes the steps of: (a) defining cost variables, codes and other related data for generating cost variable definition data; (b) defining work centers in each of operation centers, and determining cost variables of each product in order to generate operation center definition data; (c) obtaining manufacturing expenses information and saving the information as manufacturing expenses data; (d) defining cost groups, and manufacturing expenses accounts and cost variables in each cost group based on the cost variable definition data and manufacturing expenses definition data, and calculating manufacturing expenses of each cost group; (e) obtaining work time data on work orders, summing up all the work time on work orders of each work center in each operation center, and calculating an operation center total variance and product variances of each operation center; (f) defining an apportioned variance to be apportioned to each operation center from the cost group's manufacturing expenses; and (g) calculating the total product costs of each product based on the manufacturing expenses of each cost group, the apportioned variance of each operation center, the operation center total variance of each operation center, and a product variance of that product; wherein “variance” means “cost variance.”

Based on a company's manufacturing expenses and work time on work orders, the system for integration of value-added product costs can define cost variances and expenses to be apportioned to each of operation centers, calculate total costs and an expenses rate of each operation center, obtain each product's costs from each operation center, and calculate total costs of each product. The company employing the system can thus acquire each operation center's expenses rate and the cost distribution of each product. This provides invaluable information to enable the company to make well-founded strategic business decisions.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of an application environment including a system for integration of value-added product costs in accordance with a preferred embodiment of the present invention;

FIG. 2 is a schematic diagram of function modules of a web server of the system of FIG. 1;

FIG. 3 is a schematic diagram of data structure of a database of the system of FIG. 1;

FIGS. 4-1 and 4-2 in combination are a data flowchart in accordance with the preferred embodiment of the present invention;

FIG. 5 is a flowchart of preferred operation of the system for integration of value-added product costs in accordance with the present invention; and

FIG. 6 is a flowchart of details of one step shown in FIG. 5, namely calculating the total costs of each product.

### DETAILED DESCRIPTION OF PREFERRED EMBODIMENTS OF THE INVENTION

Reference will now be made to the drawings to describe the present invention in detail.

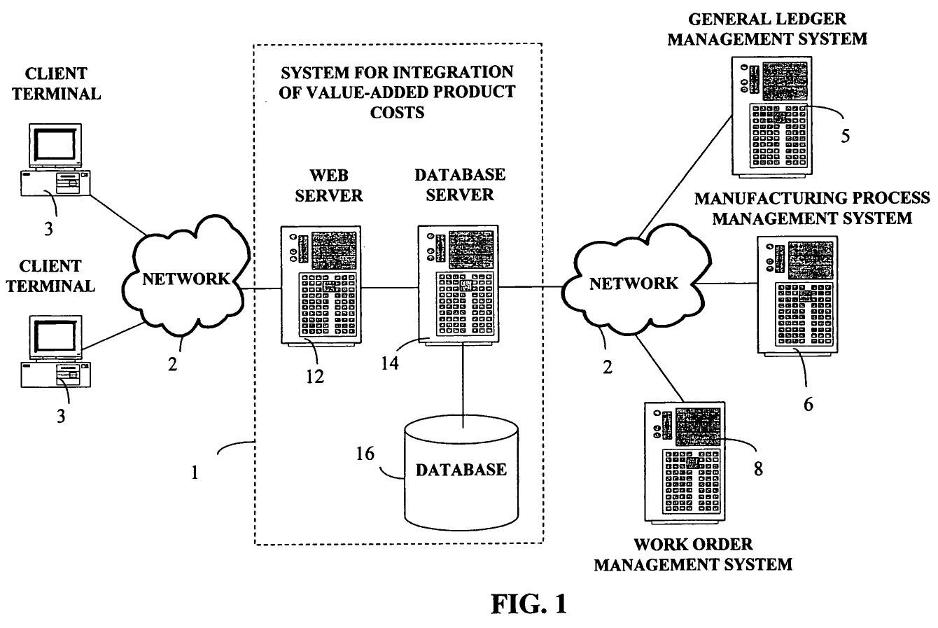

FIG. 1 is a schematic diagram of an application environment including a system for integration of value-added product costs 1 (hereafter simply referred to as the system 1) in accordance with the preferred embodiment of the present invention. The system 1 is connected to a plurality of client terminals 3, a general ledger management system 5, a manufacturing process management system 6 and a work order management system 8 via a network 2. The system 1 comprises a web server 12, a database server 14, and a database 16. The system 1 uses a web-based solution; i.e. an application program of the system 1 runs on the web server 12. Using Internet access software installed in the client terminals 3, users of the system 1 such as cost management personnel and supervisors can log in the web server 12 via the network 2 with a www (world wide web) address. The users can then perform all required operations within the system 1 and obtain relevant data. The operations include operation center maintenance, manufacturing expenses information transference, cost variable maintenance, cost group file creation, cost group apportionment, operation cost list maintenance, operation center manufacturing expenses apportionment, integration of value-added product costs, and expenses rate calculation. Value-added product costs are hereinafter referred to simply as “product costs.” The data include cost group definition data, an operation center cost variables list, a manufacturing expenses apportionment table, operation center costs, and an expenses rate table. The Internet access software is Internet Explorer from Microsoft Corp. or Navigator from Netscape Corp. The network 2 is the Internet or an intranet.

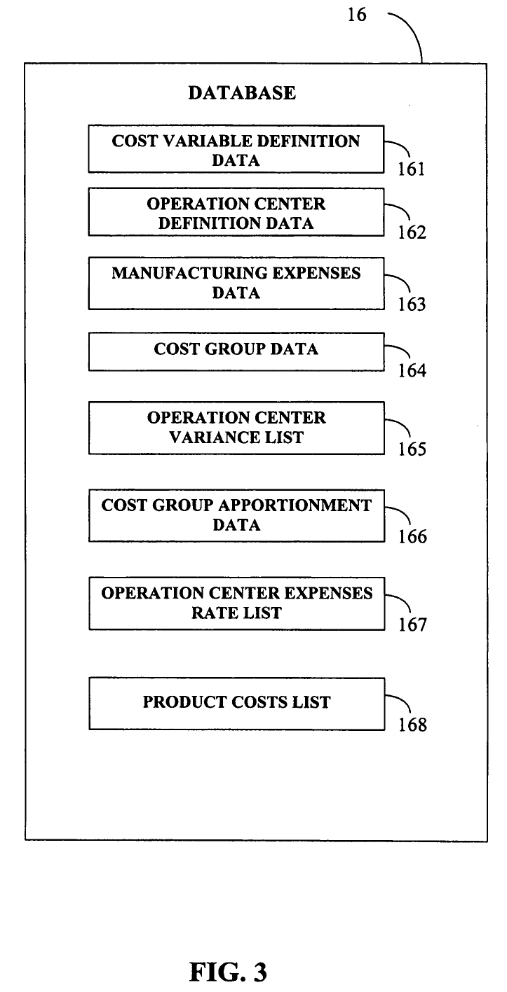

The web server 12 is connected to the database server 14, which contains the database 16. The database 16 stores relevant data of the system 1 such as cost variable definition data, operation center cost variables data, manufacturing expenses data, the cost group definition data, the operation center cost variables list, the manufacturing expenses apportionment table, the operation center costs, and the expenses rate table. A detailed structure of the database 16 is described below with reference to FIG. 3.

The database server 14 is connected to the general ledger management system 5, the manufacturing process management system 6 and the work order management system 8 via the network 2 for data transmission therebetween. The database server 14 can receive manufacturing expenses information from the general ledger management system 5, operation center basic data from the manufacturing process management system 6, and work time data from the work order management system 8.

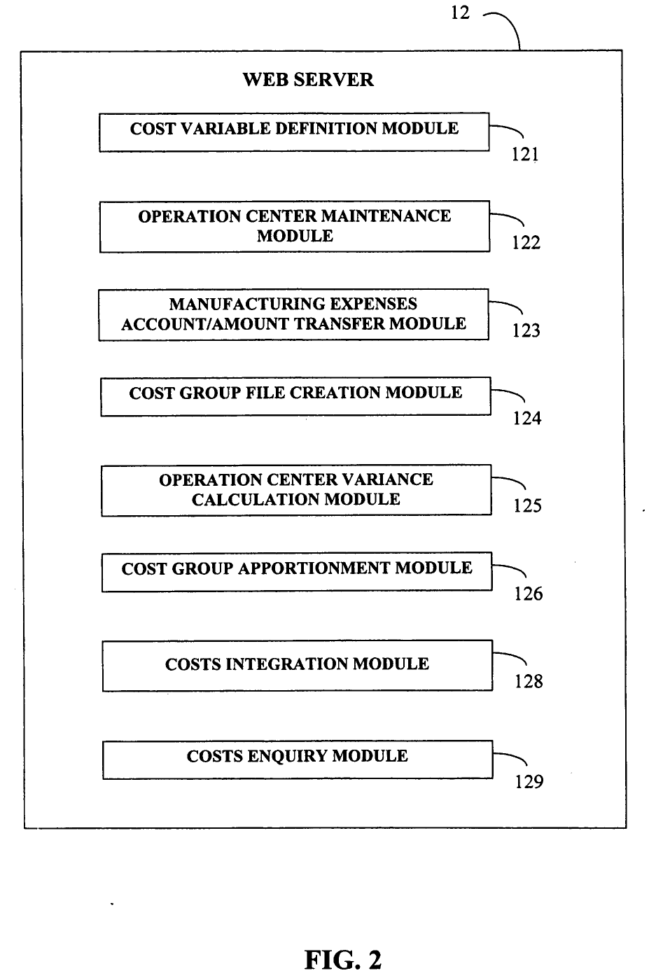

FIG. 2 is a schematic diagram of function modules of the web server 12. In the preferred embodiment, as an application server layer, the web server 12 includes core and volatile enterprise logic (plans, operation methods, management models etc.). The web server 12 also stores a series of software function modules for receiving and processing data from the client terminals 3, and for returning results to the client terminals 3 after processing. The web server 12 comprises a cost variable definition module 121, an operation center maintenance module 122, a manufacturing expenses account/amount transfer module 123, a cost group file creation module 124, an operation center variance calculation module 125, a cost group apportionment module 126, a costs integration module 128, and a costs enquiry module 129.

The cost variable definition module 121 is used for defining possible cost variables, cost variable codes and other relevant data when calculating product costs. Cost variables are factors that affect product costs, such as labor work time, machine work time, etc. In the preferred embodiment of the present invention, the cost variables can be an apportionment standard for apportioning costs of cost groups (i.e. cost categories) to operation centers (assembly lines, work stations, etc.), as well as an apportionment standard for apportioning operation center costs to product costs.

Based on operation center basic data obtained from the manufacturing process management system 6, the operation center maintenance module 122 performs operation center maintenance. That is, the operation center maintenance module 122 selects work centers in operation centers and specifies cost variables to be apportioned to product costs. Each product is a finished product, a semi-finished product or a product manufactured according to a contract. An operation center may be an assembly line, a production station, etc. Each operation center serves as a basic unit for collection of production site manufacturing expenses data.

The manufacturing expenses account/amount transfer module 123 performs manufacturing expenses account/amount transfers. In a transfer, the database server 14 obtains manufacturing expenses information from the general ledger management system 5, calculates manufacturing expenses data in a current period, and saves the data in the database 16.

The cost group file creation module 124 divides a company's department or product groups into different cost groups according to different cost variables, defines manufacturing expenses accounts and cost variables in each cost group, and calculates the manufacturing expenses of each cost group by summing up amounts of all of the manufacturing expenses accounts based on the manufacturing expenses data.

The operation center variance calculation module 125 obtains work time data on work orders from the work order management system 8. That is, the operation center variance calculation module 125 keeps a record of each work center's work time on work orders and a quantity of output of each product for the current period of cost calculations, and calculates the sum of all the operation centers' cost variances and each product's cost variance for each operation center. Cost variance is hereinafter referred to simply as “variance.” The operation center total variance of each operation center is the total of product variances for each type of product for each work center contained in that operation center. Each product variance is the product's work time on work orders (such as labor work time and machine work time). The formula for calculating the product variance of each product in one operation center is:

V=W_{T}/Q

where V stands for the product variance of the product in the operation center, W_{T} stands for the total work time on work orders of the product in the operation center, and Q stands for the total manufactured quantity of the product.

The total work time on work orders of the product in the operation center is the total of work time on work orders in each work center contained in that operation center.

The cost group apportionment module 126 specifies a ratio of each cost group's manufacturing expenses apportioned to each operation center, i.e. an apportioned variance of each operation center, and generates cost group apportionment data that are stored in the database 16. Cost group apportionment data of a previous period's cost calculations can be obtained from the cost group apportionment module 126, and used to define the cost group apportionment data of the current period. The apportioned expenses of each cost group's manufacturing expenses to be apportioned to corresponding operation centers can be determined by the sum of the operation center total variances corresponding to the cost group generated by the operation center variance calculation module 125.

The costs integration module 128 calculates each operation center's total costs by using the operation center total variance, each cost group's manufacturing costs corresponding to the operation center, and the operation center's apportioned variance. The costs integration module 128 further calculates each operation center's expenses rate and each operation center's product costs for a particular product, according to the operation center's total costs and the operation center's total variance. The formulas for calculating each operation center's total costs, expenses rate and product costs for a particular product are as follows:

operation center total costs=ΣE_{M}*(V_{A}/V_{S})

where E_{M}*(V_{A}/V_{S}) is equal to the manufacturing expenses apportioned to the operation center, and where E_{M} stands for manufacturing expenses, V_{A} stands for the apportioned variance of the operation center in a cost group, and V_{S} stands for the sum of all the operation center total variances in the cost group;

R_{E}=C_{T}/V_{T}

where R_{E} stands for the operation center's expenses rate, C_{T} stands for the operation center's total costs, and V_{T} stands for the operation center's total variance; and

C_{V}=R_{E}*V_{P}

where C_{V} stands for the operation center's product costs for a particular product, R_{E} stands for the operation center's expenses rate, and V_{P} stands for the product variance of the operation center.

Total product costs of a particular product is calculated according to the following formula:

Total product costs=Σoperation center product costs for all the operation centers.

The costs enquiry module 129 can be queried to obtain data on the total costs, the expenses rate and the product costs of each operation center.

FIG. 3 is a schematic diagram of data structure of the database 16. The database 16 stores cost variable definition data 161, operation center definition data 162, manufacturing expenses data 163, cost group data 164, an operation center variance list 165, cost group apportionment data 166, an operation center expenses rate list 167, and a product costs list 168.

The cost variable definition data 161 are generated by the cost variable definition module 121. The cost variable definition data 161 define possible cost variables and cost variable codes to be used in the product cost calculations, and include a cost variable code field, a cost variable name field, a cost variable unit field and other fields. The cost variable name field specifies the names of cost variables such as labor work time, machine work time, etc. The cost variable unit field specifies the time unit used for each cost variable, such as hours.

The operation center definition data 162 are generated by the operation center maintenance module 122, and mainly contain data on the cost variables and work centers of each operation center. The operation center definition data 162 include an operation center name field, a cost variable field, and a work center list. The cost variable field stores cost variables, which are defined by the cost variable definition data 161 and used for respective operation centers. The work center list is defined by the manufacturing process management system 6, and stores data on work centers included in each operation center.

The manufacturing expenses data 163 is generated by the manufacturing expenses account/amount transfer module 123. That is, the manufacturing expenses account/amount transfer module 123 obtains manufacturing expenses information from the general ledger management system 5. The manufacturing expenses information is then saved in the database 16 as the manufacturing expenses data 163. Thus, the manufacturing expenses data 163 stores expenses of each manufacturing expenses account, including data from a manufacturing expenses account field, an expenses field, etc.

The cost group data 164 are generated by the cost group file creation module 124. The cost group data 164 define cost variables in the company's cost groups, manufacturing expenses accounts, and manufacturing expenses. The cost group data 164 include a cost variable field, a manufacturing expenses field, and a manufacturing expenses account list. The cost variable field defines cost variables, which are retrieved from the cost variable definition data 161 and used by each particular cost group. The manufacturing expenses account list and manufacturing expenses field define a manufacturing expenses account in each particular cost group.

The operation center variance list 165 is generated by the operation center variance calculation module 125. The operation center variance list 165 stores the operation center total variance of each operation center and the product variance of each product, and includes an operation center name field, an operation center total variance field, and a product variance list field. The names of operation centers are defined by the operation center definition data 162. The product variance list field includes product names and product variances.

The cost group apportionment data 166 are generated by the cost group apportionment module 125. The cost group apportionment data 166 store the apportioned variance of each operation center in each cost group, and include a cost group name field, an operation center name field and an apportioned variance field.

The operation center expenses rate list 167 is generated by the costs integration module 125. The operation center expenses rate list 167 stores the operation center total variance and expenses rate for each operation center, and includes an operation center name field, a cost variance field, a total costs field and an expenses rate field.

The product costs list 168 is generated by the costs integration module 125. The product costs list 168 stores total product costs of each product, and costs in each operation center. The product costs list 168 includes a product name field, a cost variance name field, a total product costs field, and an operation center costs list. The operation center costs list includes an operation center name field and a costs field.

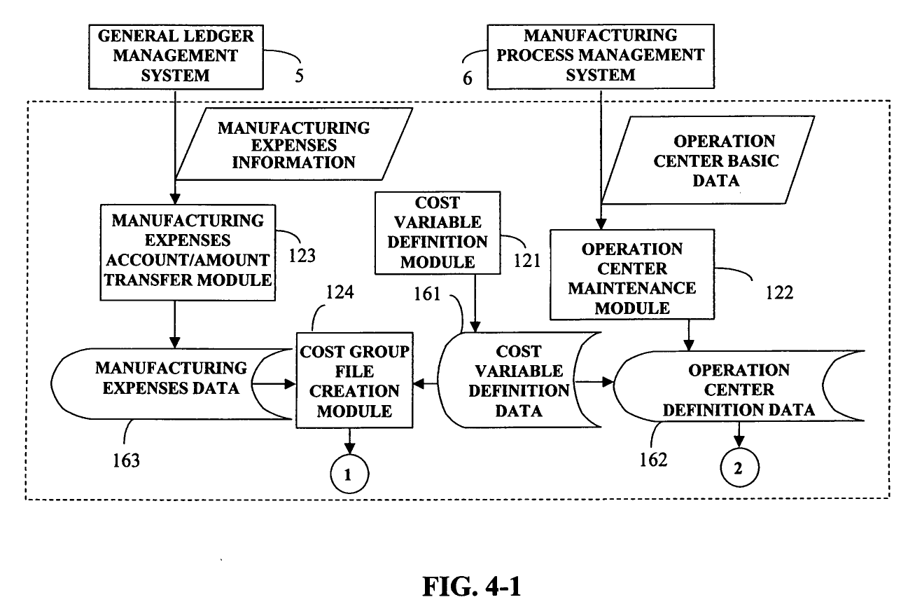

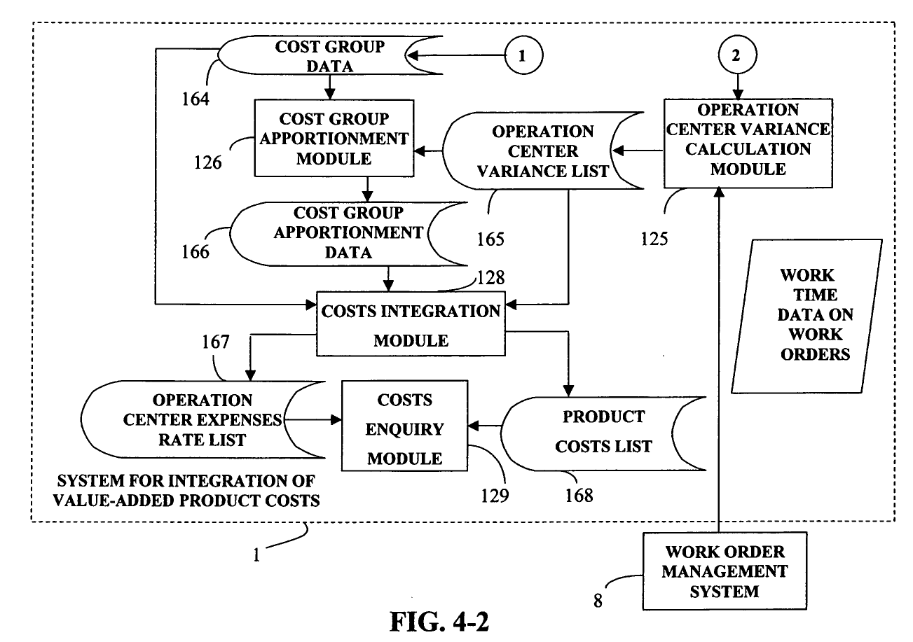

FIGS. 4-1 and 4-2 in combination are a data flowchart in accordance with the preferred embodiment of the present invention. In the preferred embodiment, the cost variable definition module 121 defines cost variables, codes and other related data that are likely to be used in product cost calculations, and generates the cost variable definition data 161. The operation center maintenance module 122 obtains operation center basic data from the manufacturing process management system 6, defines the work centers of each operation center, determines the cost variables of each product based on the cost variable definition data 161, and thereby generates the operation center definition data 162. The manufacturing expenses account/amount transfer module 123 obtains the current period's manufacturing expenses information from the general ledger management system 5, and saves the information in the database 16 as the manufacturing expenses data 163. The cost group file creation module 124 defines cost groups, manufacturing expenses accounts and cost variables in each cost group in accordance with the manufacturing expenses data 163 and the cost variable definition data 161, and calculates manufacturing expenses of each cost group to thereby generate the cost group data 164. The operation center variance calculation module 125 obtains the current period's work time data on work orders from the work order management system 8. The operation center variance calculation module 125 also sums up all the work centers' work time on work orders in each operation center based on said work time data and definitions of the operation center definition data 162. The total obtained is the operation center total variance for the operation center. The operation center variance calculation module 125 further calculates each product variance of each operation center to thereby generate the operation center variance list 165. In accordance with the cost group data 164 and the operation center variance list 165, the cost group apportionment module 126 defines an apportioned variance allocated from a cost group's manufacturing expenses to each operation center, and generates the current period's cost group apportionment data 166. The cost group apportionment module 126 also defines an apportioned variance allocated from a cost group's manufacturing expenses to each operation center in accordance with the previous period's cost group apportionment data 166, and said apportioned variance is also used in generating the current period's cost group apportionment data 166. The costs integration module 128 stores each operation center's total variance, each cost group's costs for each operation center and each operation center's apportioned variance based on the manufacturing expenses data 163, the current period's cost group apportionment data 166 and the operation center variance list 165, in order to calculate each operation center's total costs. Based on the total costs of each operation center and operation center total variance of each operation center, the costs integration module 128 also calculates each operation center's expenses rate and product costs of each product to generate the operation center expenses rate list 167 and the product costs list 168. The costs enquiry module 129 enquires of the operation center expenses rate list 167 and the product costs list 168 to obtain relevant data, and sends the enquiry results to the client terminals 3.

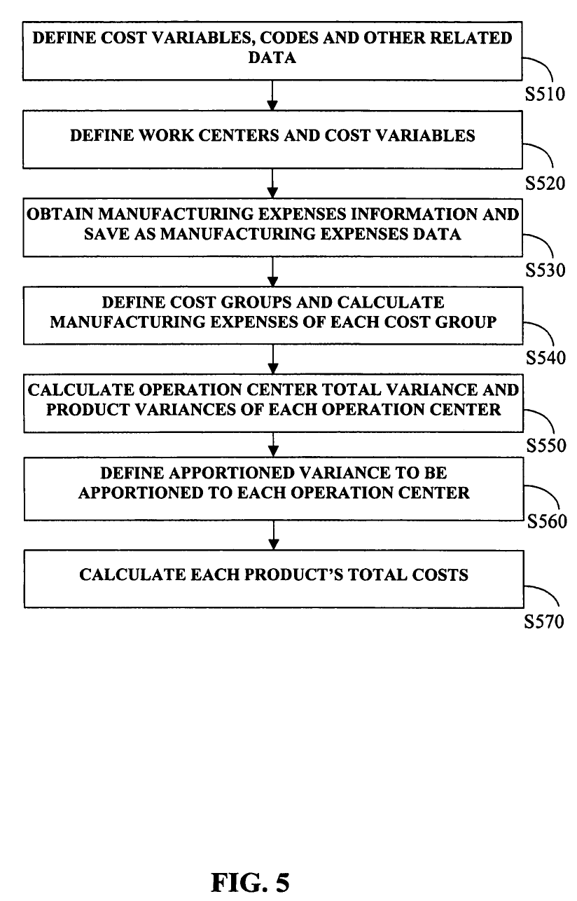

FIG. 5 is a flowchart of preferred operation of the system 1, in accordance with the present invention. In step S510, cost management personnel perform cost variable maintenance by using the cost variable definition module 121. That is, said personnel define cost variables, codes and other related data which are likely to be used during product cost calculations to generate the cost variable definition data 161. In step S520, the cost management personnel perform operation maintenance by using the operation center maintenance module 122. That is, said personnel obtain operation center basic data from the manufacturing process management system 6. Said personnel define work centers in each operation center and determine cost variables of each product's costs, based on the operation center basic data and the cost variable definition data 161. The operation center definition data 162 are thereby generated. In step S530, the manufacturing expenses account/amount transfer module 123 obtains manufacturing expenses information from the general ledger management system 5, and saves the information in the database 16 as the manufacturing expenses data 163. In step S540, the cost group file creation module 124 creates a cost group file. That is, the cost group file creation module 124 defines the cost groups, defines manufacturing expenses accounts and cost variables in each cost group, calculates the manufacturing expenses of each cost group, and thereby generates the cost group data 164. In step S550, the operation center variance calculation module 125 sums up all the work time on work orders of each work center in each operation center based on work time data on work orders of the current period obtained from the work order management system 8 and definitions of the operation center definition data 162, calculates the operation center total variance and product variances of each operation center, and thereby generates the operation center variance list 165. In step S560, the cost group apportionment module 126 defines the apportioned variance to be apportioned to each operation center from the cost group's manufacturing expenses. The cost group apportionment data 166 are thereby generated. In step S570, the costs integration module 128 calculates the total product costs of each product based on the manufacturing expenses of each cost group, the apportioned variance of each operation center, the operation center total variance of each operation center and the product variance of the product.

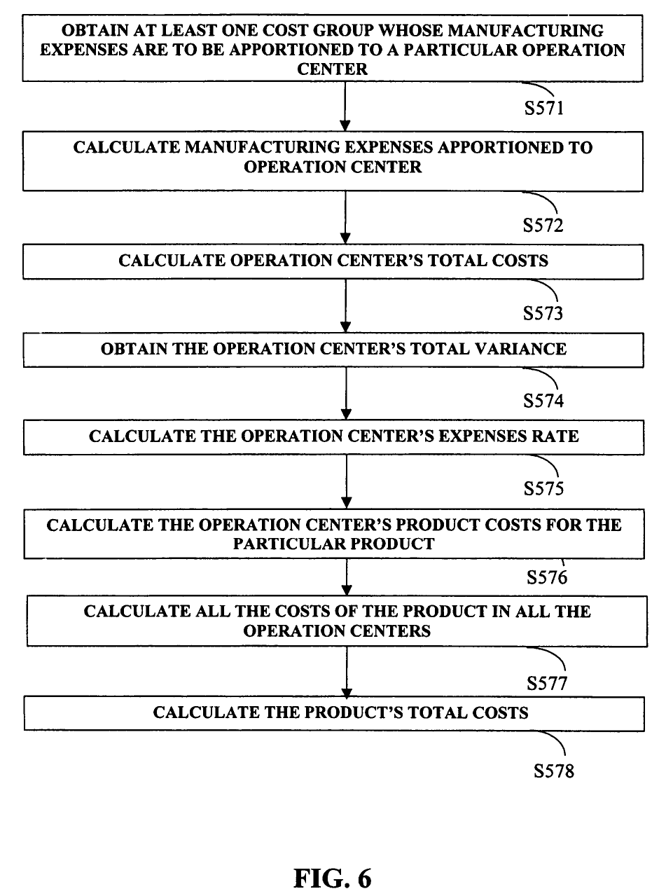

FIG. 6 is a flowchart of details of step S570 of FIG. 5, namely calculating the total product costs of each product. In step S571, using an operation center name as an enquiry keyword, the costs integration module 128 searches the cost group apportionment data 166 to obtain data for at least one cost group whose manufacturing expenses are to be apportioned to the particular operation center. In step S572, the costs integration module 128 calculates manufacturing expenses apportioned to the operation center by using the following formula:

A_{C}=C_{G}*(V_{A}/TV_{A})

where A_{C} stands for the apportioned costs of the operation center, C_{G} stands for the costs of a cost group, V_{A} stands for the apportioned variance of the operation center, and TV_{A} stands for the total apportioned variances of all the operation centers.

In step S573, the total costs of the operation center is calculated by summing up all the manufacturing expenses apportioned to the operation center; that is, by using the following formula:

operation center total costs=ΣE_{M}*(V_{A}/V_{S})

where E_{M}*(V_{A}/V_{S}) is equal to the manufacturing expenses apportioned to the operation center, and where E_{M} stands for manufacturing expenses, V_{A} stands for the apportioned variance of the operation center in a cost group, and V_{S} stands for the sum of all the operation center total variances in the cost group.

In step S574, the operation center total variance is obtained by searching the operation center variance list 165, using the operation center's name as an enquiry keyword. In step S575, the operation center's expenses rate is calculated by using the following formula:

R_{E}=C_{T}/V_{T}

where R_{E} stands for the operation center's expenses rate, C_{T} stands for the total costs of the operation center, and V_{T} stands for the operation center's total variance.

In step S576, the operation center product costs for the particular product is calculated by using the following formula:

C_{V}=R_{E}*V_{P}

where C_{V} stands for the operation center product costs for the particular product, R_{E} stands for the expenses rate of the operation center, and V_{P} stands for the product variance of the operation center which is obtained by enquiry of the operation center variance list 165.

Steps S571 through S575 are repeated so that in step S577, all the product costs of the product in all the operation centers are calculated. In step S578, all these product costs are summed up, so that the total product costs of that product is obtained.

Although only preferred embodiments of the present invention have been described in detail above, those skilled in the art will readily appreciate that many modifications to the preferred embodiments are possible without materially departing from the novel teachings and advantages of the present invention. Accordingly, all such modifications are deemed to be covered by the following claims and allowable equivalents of the claims.

What is claimed is:

1. A system for integration of value-added product costs (hereinafter “product costs”) for calculating product costs of a product based on manufacturing expenses and work time data on work orders, the system comprising a web server and a database server, wherein:
the database server comprises a database for storing cost variable definition data, operation center definition data and manufacturing expenses data, said cost variable definition data comprising cost variance (hereinafter “variance”) related data including a cost variable code field, a cost variable name field, a cost variable unit field and other fields, said operation center definition data comprising data on cost variables and work centers of each of operation centers, said manufacturing expenses data comprising expenses of each of manufacturing expenses accounts; and
the web server comprises:
a cost group file creation module, for defining cost groups, manufacturing expenses accounts and cost variables in each cost group, and for calculating the manufacturing expenses of each cost group based on the manufacturing expenses data and the cost variable definition data;
an operation center variance calculation module for calculating the sum of all the operation centers' variances and each product's variance for each operation center, based on the operation center definition data and the work time data on work orders;
a cost group apportionment module for specifying a ratio of each cost group's manufacturing expenses apportioned to each operation center; and
a costs integration module for calculating each operation center's total costs, each cost group's manufacturing costs corresponding to the operation center, and the operation center's apportioned variance.

2. The system for integration of product costs as claimed in claim 1, wherein the web server further comprises a manufacturing expenses account/amount transfer module which obtains manufacturing expenses information, calculates manufacturing expenses data, and stores the manufacturing expenses data in a database.

3. The system for integration of product costs as claimed in claim 1, wherein the web server further comprises a cost variable definition module for defining cost variables, cost variable codes and other relevant data.

4. The system for integration of product costs as claimed in claim 1, wherein the web server further comprises an operation center maintenance module for selecting work centers in operation centers and specifying cost variables to be apportioned to product costs.

5. The system for integration of product costs as claimed in claim 1, wherein the web server further comprises a costs enquiry module for handling queries to obtain data on total costs, an expenses rate and product costs of each operation center.

6. The system for integration of product costs as claimed in claim 1, wherein the cost group file creation module is used for summing up amounts of all of the manufacturing expenses accounts based on the manufacturing expenses data.

7. The system for integration of product costs as claimed in claim 1, wherein the operation center variance calculation module sums up all work time on work orders of each work center of each operation center, for calculating an operation center total variance and product variances of each operation center.

8. The system for integration of product costs as claimed in claim 1, wherein the costs integration module calculates each operation center's total costs based on the cost group apportionment variance of the operation center, and calculates each operation center's expenses rate and each operation center's product costs for each product.

9. A computer-enabled method for integration of value-added product costs (hereinafter “product costs”) for calculating product costs of a product based on manufacturing expenses and work time on work orders, the method comprising the steps of:
(a) defining cost variables, codes and other related data for generating cost variable definition data;
(b) defining work centers in each of operation centers, and determining cost variables of each product in order to generate operation center definition data;
(c) obtaining manufacturing expenses information and saving the information as manufacturing expenses data;
(d) defining cost groups, and manufacturing expenses accounts and cost variables in each cost group based on the cost variable definition data and manufacturing expenses definition data, and calculating manufacturing expenses of each cost group;
(e) obtaining work time data on work orders, summing up all the work time on work orders of each work center in each operation center, and calculating an operation center total variance and product variances of each operation center;
(f) defining an apportioned variance to be apportioned to each operation center from the cost group's manufacturing expenses; and
(g) calculating the total product costs of each product based on the manufacturing expenses of each cost group, the apportioned variance of each operation center, the operation center total variance of each operation center, and a product variance of that product;
wherein “variance” means “cost variance.”

10. The method for integration of product costs as claimed in claim 9, wherein step (b) further comprises the step of selecting work centers in each operation center.

11. The method for integration of product costs as claimed in claim 9, wherein in step (d), the manufacturing expenses of each cost group is obtained by adding up the amounts of manufacturing expenses accounts of each cost group.

12. The method for integration of product costs as claimed in claim 9, wherein in step (e), the work time data on work orders comprises work time on work orders and an output quantity of each product in each work center.

13. The method for integration of product costs as claimed in claim 12, wherein in step (e), each product's total work time is obtained by adding up all the work times on work orders of the product from all the operation centers.

14. The method for integration of product costs as claimed in claim 13, wherein in step (e), each product's work time in each operation center is obtained by adding up the product's work time on work orders of all the work centers of the operation center.

15. The method for integration of product costs as claimed in claim 9, wherein step (g) comprises the step of: (g1) calculating manufacturing expenses apportioned to each operation center.

16. The method for integration of product costs as claimed in claim 15, wherein step (g) further comprises the step of: (g2) calculating each operation center's expenses rate based on the total costs of the operation center and the operation center's total variance.

17. The method for integration of product costs as claimed in claim 16, wherein step (g) further comprises the step of: (g3) calculating the operation center product costs for a particular product in each operation center, based on the expenses rate of the operation center and the product variance of the operation center;

18. The method for integration of product costs as claimed in claim 17, wherein step (g) further comprises the step of: (g4) adding up the operation center product costs for the particular product in all the operation centers, to obtain the total product costs for the particular product.
